(19) United States
(12) Patent Application Publication
(10) Pub. No.: US 2012/0236705 A1
(43) Pub. Date: Sep. 20, 2012

(54) MANAGEMENT APPARATUS, COMMUNICATION SYSTEM, AND COMMUNICATION METHOD

(75) Inventors: Shinichi HAYASHI, Fukuoka (JP); Tadashi Iwahashi, Fukuoka (JP)

(73) Assignee: FUJITSU LIMITED, Kawasaki-shi (JP)

(21) Appl. No.: 13/418,709

(22) Filed: Mar. 13, 2012

(30) Foreign Application Priority Data
Mar. 18, 2011 (JP) 2011-061778

(51) Int. Cl. H04L 12/26

(52) U.S. Cl. 370/216

(57) ABSTRACT

A management apparatus is communicable with a plurality of detection apparatuses for detecting a loss of a packet transmitted from a source apparatus to a destination apparatus. The plurality of detection apparatuses are disposed on a communication path of a connection between the source apparatus and the destination apparatus. The management apparatus includes a processor. The processor acquires, upon receiving a notice of the loss of a packet from a first detection apparatus, the lost packet from a second detection apparatus disposed on a communication path between the source apparatus and the first detection apparatus. The processor transmits the lost packet to a third detection apparatus disposed on a communication path between the first detection apparatus and the destination apparatus.

### CROSS-REFERENCE TO RELATED APPLICATION

This application is based upon and claims the benefit of priority of the prior Japanese Patent Application No. 2011-061778, filed on Mar. 18, 2011, the entire contents of which are incorporated herein by reference.

### FIELD

The embodiments discussed herein are related to a management apparatus, a communication system, and a communication method.

### BACKGROUND

In traditional data communication, data is transmitted from a source host to a destination host through routers in accordance with a connection-oriented communication protocol, such as a Transmission Control Protocol (TCP). For example, as illustrated in FIG. 15, a source host 1 transmits data to a destination host 2 through a plurality of routers 3A to 3D. FIG. 15 is a diagram illustrating a traditional network configuration of a communication system. During normal communication between the source host 1 and the destination host 2, the destination host 2 sends back an acknowledgement (ACK) message, serving as a confirmation response, using a standard function of the communication protocol in response to data transmitted from the source host 1.

If packet loss is caused due to any failure over the network, the destination host 2 will not send back any ACK message for a lost packet. A process of data retransmission in the event of packet loss will be discussed with reference to FIG. 16. FIG. 16 is a diagram for explaining a traditional process of data retransmission in the event of packet loss. In FIG. 16, it is assumed that packet loss has occurred between the routers 3C and 3D in a communication system. As illustrated in FIG. 16, in the case where the source host 1 has not received an ACK message for a transmitted packet for over a given period of time, the source host 1 detects time-out for receiving an ACK message and attempts to retransmit the packet. After that, if the source host 1 has not received any ACK message, the source host 1 will attempt to retransmit data by repeating data transmission several times while changing the time interval between retransmissions.

In data recovery based on such a retransmission function according to the communication protocol, after the occurrence of packet loss, the source host 1 may take a long time to recognize the occurrence of a failure and start retransmission. According to a known method, therefore, a signal splitter called a test access point (TAP) is disposed on the network, the TAP is connected to a detection apparatus called a network probe (hereinafter, referred to as a “probe”) in order to detect packet loss, and if packet loss is detected, packet retransmission is performed. For example, as illustrated in FIG. 17, TAPs 5 are arranged on links between apparatuses among the source host 1, routers 3A to 3F, and the destination host 2. In addition, probes 4A to 4H are connected to the respective TAPs 5 in order to detect packet loss. FIG. 17 is a diagram illustrating arrangement of the probes in the network.

Each of the probes 4A to 4H holds packets streaming through the network for a given period of time to analyze packet data, and checks the consistency of sequence numbers according to the connection-oriented communication protocol, thus detecting packet loss. In the case where any of the probes 4A to 4H detects packet loss, the source host 1 retransmits a packet to the destination host 2 and repeats packet retransmission until the destination host 2 receives the retransmitted packet.

Since the source host 1 repeats packet retransmission for the destination host 2, it may take time until the destination host 2 receives the retransmitted packet. Furthermore, in the case where a retransmission process is performed, loads of the retransmission process may be focused on the source host 1.

According to another known method, as illustrated in FIG. 18, a mechanism for detecting packet loss in a manner similar to that the probe performs is attached to each of the routers 3A to 3F on the network and each router requests a previous router on a relay route to retransmit a packet. FIG. 18 is a diagram for explaining a traditional process of requesting retransmission in the event of packet loss. According to this method, the previous router, which has received a retransmission request, searches a buffer that has stored a given amount of relayed packets. If the previous router detects a target packet relevant to the retransmission request, the previous router retransmits the target packet to the destination host 2. For example, as illustrated in FIG. 18, in the case where the router 3D detects packet loss between the router 3D and the router 3C which is a previous router in a communication system, the router 3D requests the router 3C to retransmit a packet. The router 3C searches a buffer included therein. If the router 3C detects a target packet relevant to such a retransmission request, the router 3C retransmits the target packet to the destination host 2.

Japanese Laid-open Patent Publication Nos. 2007-67814, 2003-333577, and 2003-304273 disclose related techniques.

The above-discussed technique of requesting a router to retransmit a packet has a disadvantage in that it is difficult to immediately and reliably retransmit a lost packet. Specifically, since the packet is retransmitted to the destination host in the related art, packet loss is likely to occur even if a previous router retransmits a packet under such a circumstance that packet loss often occurs at a specific point. Therefore, it is difficult to immediately and reliably retransmit the lost packet.

### SUMMARY

According to an aspect of the present invention, provided is a management apparatus communicable with a plurality of detection apparatuses for detecting a loss of a packet transmitted from a source apparatus to a destination apparatus. The plurality of detection apparatuses are disposed on a communication path of a connection between the source apparatus and the destination apparatus. The management apparatus includes a processor. The processor acquires, upon receiving a notice of the loss of a packet from a first detection apparatus, the lost packet from a second detection apparatus disposed on a communication path between the source apparatus and the first detection apparatus. The processor transmits the lost packet to a third detection apparatus disposed on a communication path between the first detection apparatus and the destination apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a network configuration of a communication system according to a first embodiment;

FIG. 2 is a diagram illustrating hardware configurations of a manager and a probe;

FIG. 3 is a block diagram illustrating a functional configuration of a manager in a first embodiment;

FIG. 4 is a diagram illustrating an example of statistical information upon establishment of a TCP connection;

FIG. 5 is a diagram illustrating an example of routing information;

FIG. 6 is a diagram illustrating a communication path between a source host and a destination host;

FIG. 7 is a diagram illustrating an example of failure information in the event of packet loss;

FIG. 8 is a block diagram illustrating a functional configuration of a probe in a first embodiment;

FIG. 9 is a diagram for explaining a packet loss recovery process performed by a manager and probes;

FIG. 10 is a flowchart illustrating a procedure of a manager in a first embodiment;

FIG. 11 is a flowchart illustrating a procedure of a probe in a first embodiment;

FIG. 12 is a flowchart illustrating a procedure of a manager in a second embodiment;

FIG. 13 is a flowchart illustrating a procedure of a manager in a third embodiment;

FIG. 14 is a diagram illustrating a hardware configuration of a computer that performs a packet loss recovery process;

FIG. 15 is a diagram illustrating a traditional network configuration of a communication system;

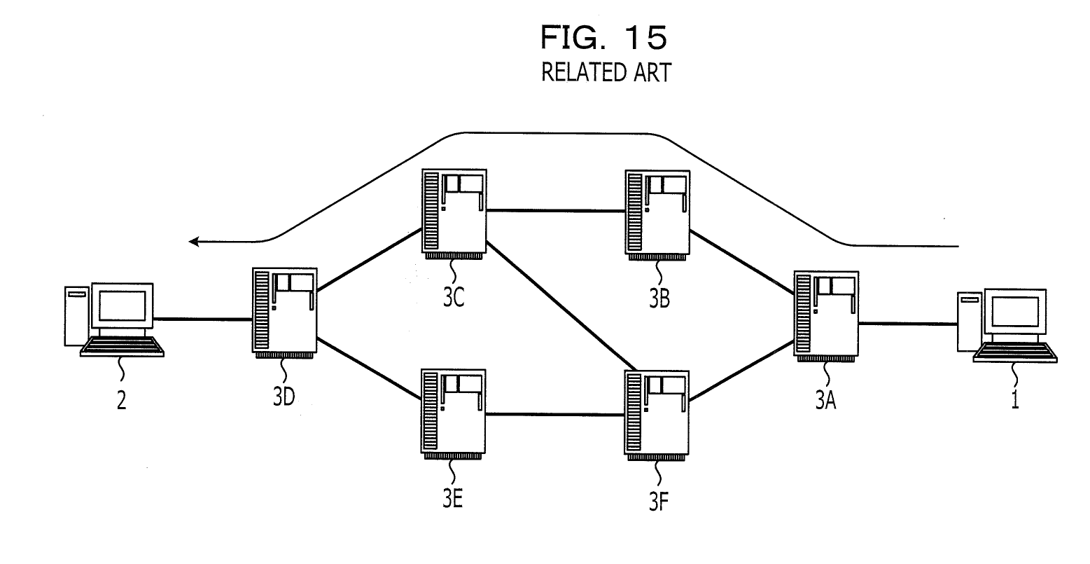

FIG. 16 is a diagram for explaining a traditional process of data retransmission in the event of packet loss;

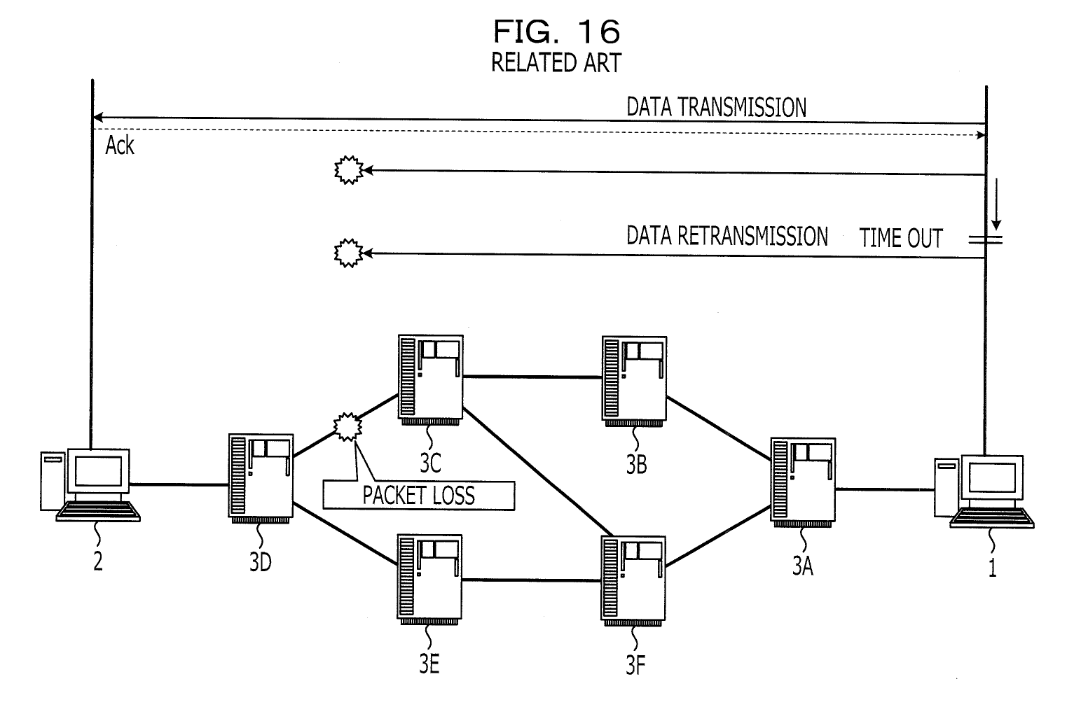

FIG. 17 is a diagram illustrating an example of probe arrangement in a network; and

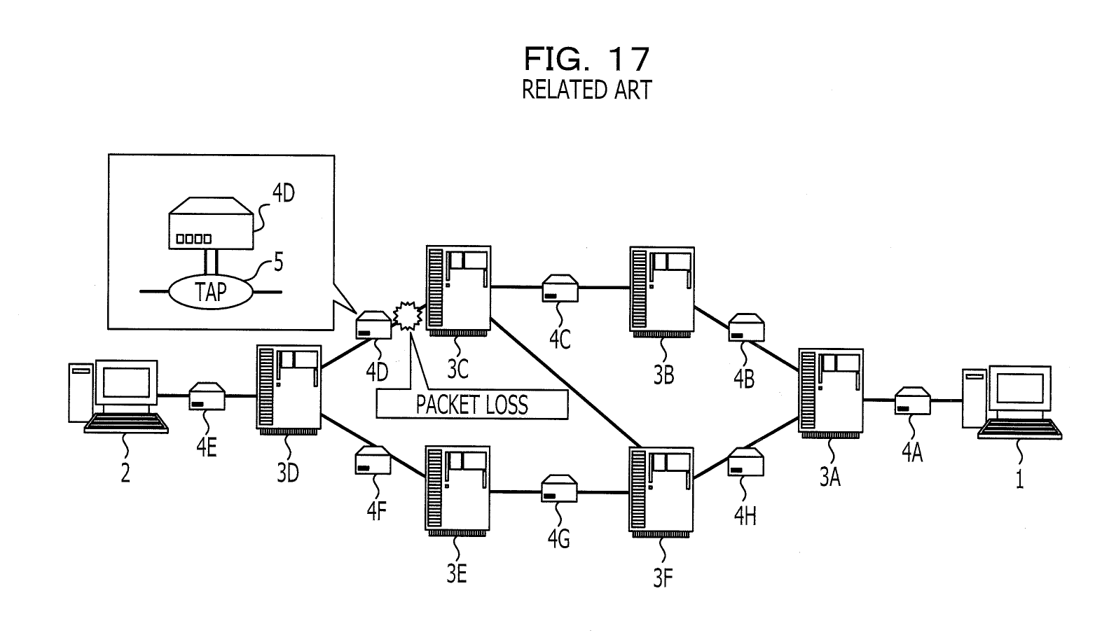

FIG. 18 is a diagram for explaining a traditional process of requesting retransmission in the event of packet loss.

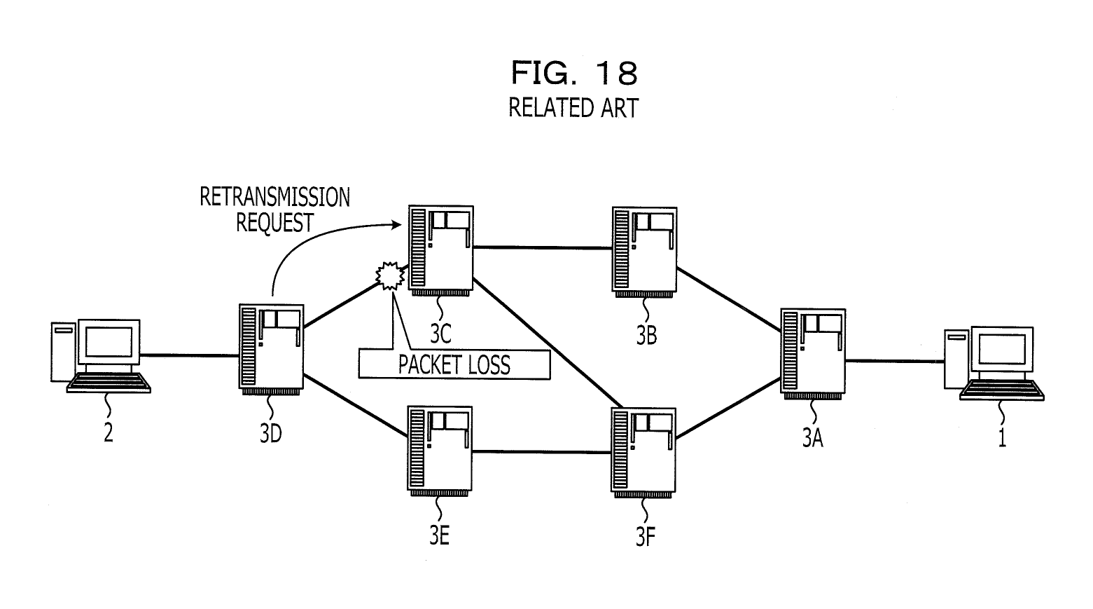

### DESCRIPTION OF EMBODIMENTS

A management apparatus, a communication system, and a communication method according to embodiments will be discussed in detail below with reference to the accompanying drawings.

### First Embodiment

Regarding a first embodiment, a network configuration of a communication system, a hardware configuration and a functional configuration of a management apparatus (hereinafter, referred to as a “manager”), a hardware configuration and a functional configuration of a probe, a procedure of the manager, a procedure of the probe and advantages of the first embodiment will be subsequently discussed below.

Network Configuration of Communication System

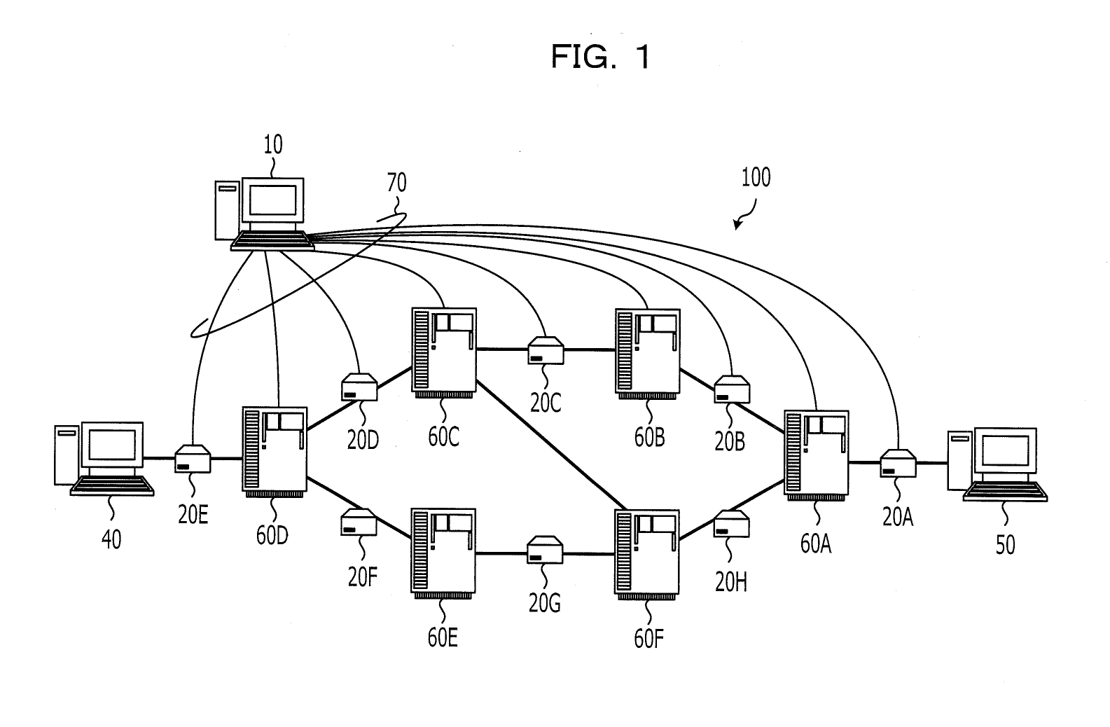

First, the network configuration of a communication system according to the first embodiment will be discussed with reference to FIG. 1. The communication system 100 includes a manager 10, a plurality of probes 20A to 20H, a destination host 40, a source host 50, and a plurality of routers 60A to 60F.

The manager 10 is a server for managing an entire state of the network. The manager 10 is connected to the probes 20A to 20H and the routers 60A to 60F via maintenance links 70. The manager 10 periodically receives statistical information about packets captured by the probes 20A to 20H through the maintenance links 70. Furthermore, the manager 10 periodically receives routing information acquired by the routers 60A to 60F in accordance with a protocol, such as Open Shortest Path First (OSPF), through the maintenance links 70. Thus, the manager 10 gets information about the whole of the network to display traffic statistics regarding the network and routing information about a path between hosts, for a user through a graphical user interface (GUI).

Each of the probes 20A to 20H captures packets transmitted between the destination host 40 and the source host 50 and stores the captured packets in a reception buffer for a given period of time. The probes 20A to 20H each analyze header information of an Internet Protocol (IP) header or a TCP header contained in the packets and periodically transmit statistical information indicative of the result of analysis to the manager 10 through the maintenance links 70.

The routers 60A to 60F each relay a packet transmitted between the destination host 40 and the source host 50 over the network. In addition, the routers 60A to 60F each periodically transmit routing information acquired in accordance with the protocol, such as OSPF, to the manager 10 through the maintenance links 70.

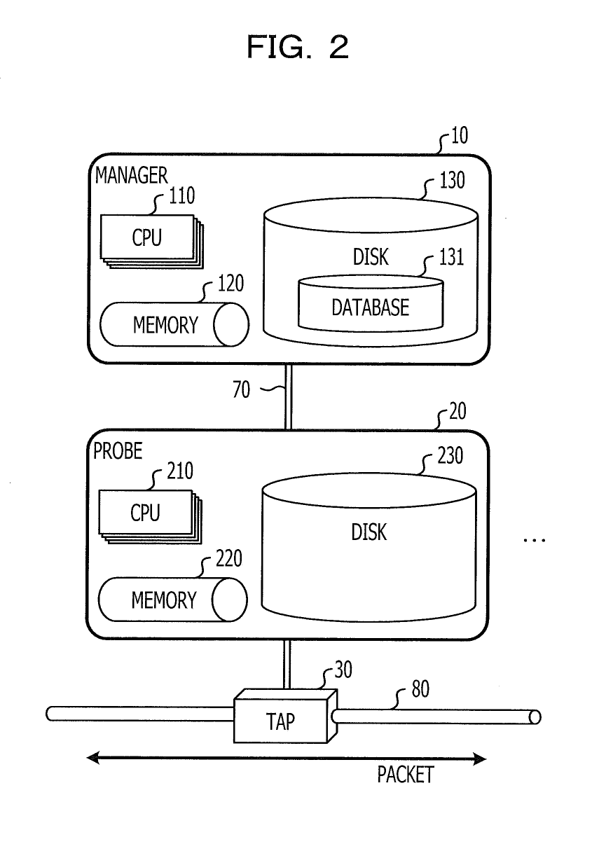

Hardware configurations of the manager 10 and each probe 20 will be discussed with reference to FIG. 2. FIG. 2 is a diagram illustrating the hardware configurations of the manager and the probe. As illustrated in FIG. 2, the manager 10 includes a central processing unit (CPU) 110, a memory 120, a disk 130, and a database 131. The CPU 110 reads data from the disk 130, stores the data into the memory 120, and performs a process on the basis of the data stored in the memory 120. The disk 130 stores data and programs used for various processes. The database 131 stores data, such as statistical information and routing information about packets, which will be discussed later.

The probe 20 includes a CPU 210, a memory 220, and a disk 230. The CPU 210 reads data from the disk 230, stores the data into the memory 220, and performs a process on the basis of the data stored in the memory 220. The disk 230 stores data, such as statistical information about captured packets. The probe 20 is connected to the manager 10 via the maintenance link 70. The probe 20 is connected to a TAP 30 and receives a packet, which is detected by the TAP 30, on a data link 80. The data link 80 is a link provided for packet communication between routers among the routers 60A to 60F that are arranged between the destination host 40 and the source host 50.

Functional Configuration of Manager

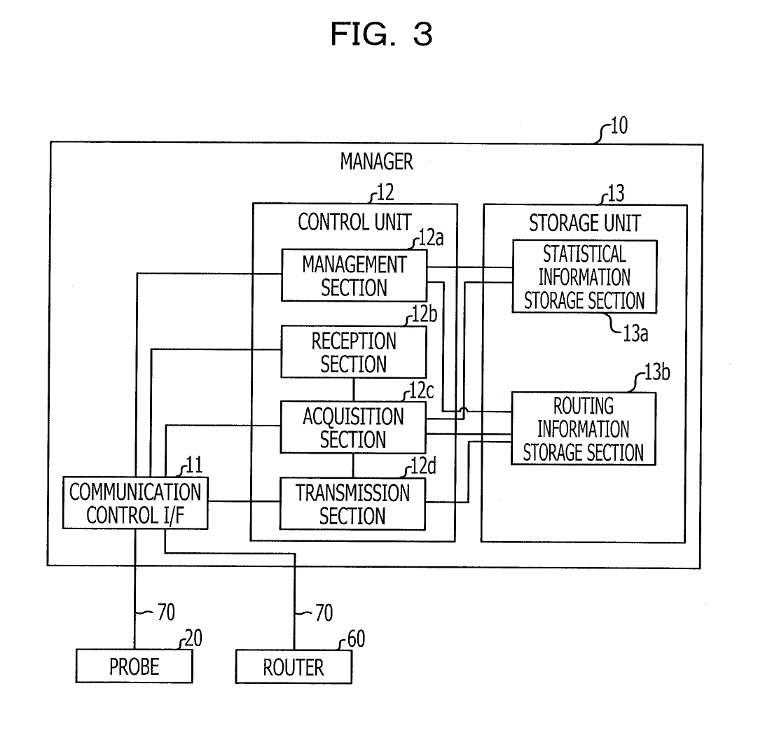

The functional configuration of the manager 10 illustrated in FIG. 1 will be discussed with reference to FIG. 3. FIG. 3 is a block diagram illustrating the functional configuration of the manager 10 in the first embodiment. As illustrated in FIG. 3, the manager 10 includes a communication control interface (I/F) 11, a control unit 12, and a storage unit 13, and is connected to each probe 20 and each router 60 via the maintenance links 70. Processes of the above-discussed components will be discussed below.

The communication control I/F 11 controls communication related to various information items transmitted between the manager 10 and each probe 20 and between the manager 10 and each router 60. For example, the communication control I/F 11 receives statistical information about packets in a TCP connection from the probe 20. Specifically, the communication control I/F 11 receives, from the probe 20, statistical information about packets, such as a source port number, a destination host name, a destination host IP address, and a destination port number. Furthermore, the communication control I/F 11 periodically receives routing information according to a routing protocol, such as OSPF routing information, from the router 60.

The storage unit 13 stores data and programs used for various processes performed by the control unit 12. The storage unit 13 includes a statistical information storage section 13a and a routing information storage section 13b. The storage unit 13 may be a semiconductor memory device, such as a random access memory (RAM), a read only memory (ROM), or a flash memory, alternatively, a storage device, such as a hard disk or an optical disk.

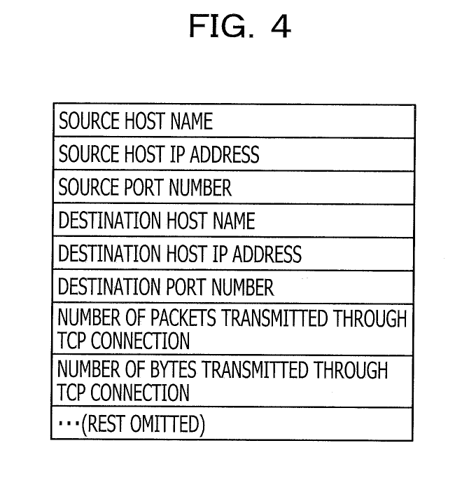

The statistical information storage section 13a stores statistical information about packets, which is transmitted from each probe 20. For example, the statistical information storage section 13a stores statistical information in a TCP connection. An example of statistical information in the TCP connection will be discussed with reference to FIG. 4. FIG. 4 is a diagram illustrating an example of statistical information upon establishment of the TCP connection. As illustrated in FIG. 4, the statistical information storage section 13a stores a source host name, source host IP address, a source port number, a destination host name, a destination host IP address, a destination port number, the number of packets transmitted through the TCP connection, and the number of bytes transmitted through the TCP connection, as the statistical information.

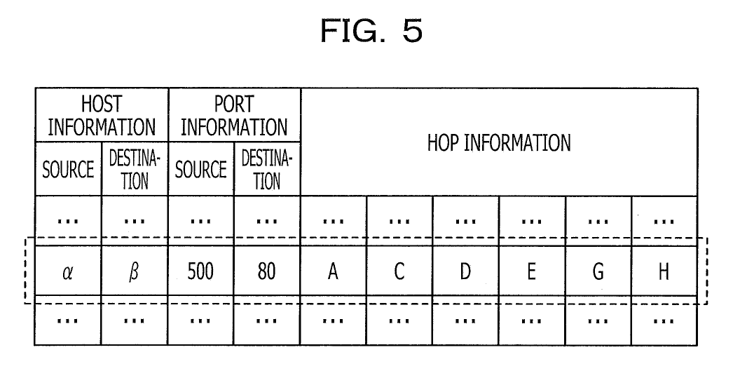

The routing information storage section 13b stores information, which is transmitted from each router 60, concerning a packet communication path for each connection. For example, the routing information storage section 13b stores a connection management table as illustrated in FIG. 5, as the routing information. FIG. 5 is a diagram illustrating an example of the routing information. As illustrated in FIG. 5, the routing information storage section 13b stores the connection management table including host information identifying a destination host and a source host, port information indicative of a destination port number and a source port number, and Hop information indicative of the number of hops between the source and the destination. FIG. 5 illustrates that a connection with a source port number “500” and a destination port number “80” is established between a source host a and a destination host β, and that the probes 20 are arranged in this order of A, C, D, E, G, and H on a path used for communication.

The control unit 12 includes an internal memory for storing programs defining various procedures and data and performs various processes on the basis of the programs and data. The control unit 12 further includes a management section 12a, a reception section 12b, an acquisition section 12c, and a transmission section 12d.

The management section 12a manages routing information concerning packet paths and statistical information indicative of the results of analysis of packets captured by the probe 20. For example, the management section 12a periodically receives statistical information in a TCP connection from each probe 20 and stores the received statistical information into the statistical information storage section 13a.

Furthermore, the management section 12a periodically receives, from each router 60, routing information (e.g., OSPF routing information) according to a routing protocol transmitted between the routers 60 in the network and stores the received routing information into the routing information storage section 13b. As discussed above, the management section 12a periodically receives information concerning paths from the routers 60 to manage, in real time, the relationship between each router 60 and links, and a high-priority path between the routers 60.

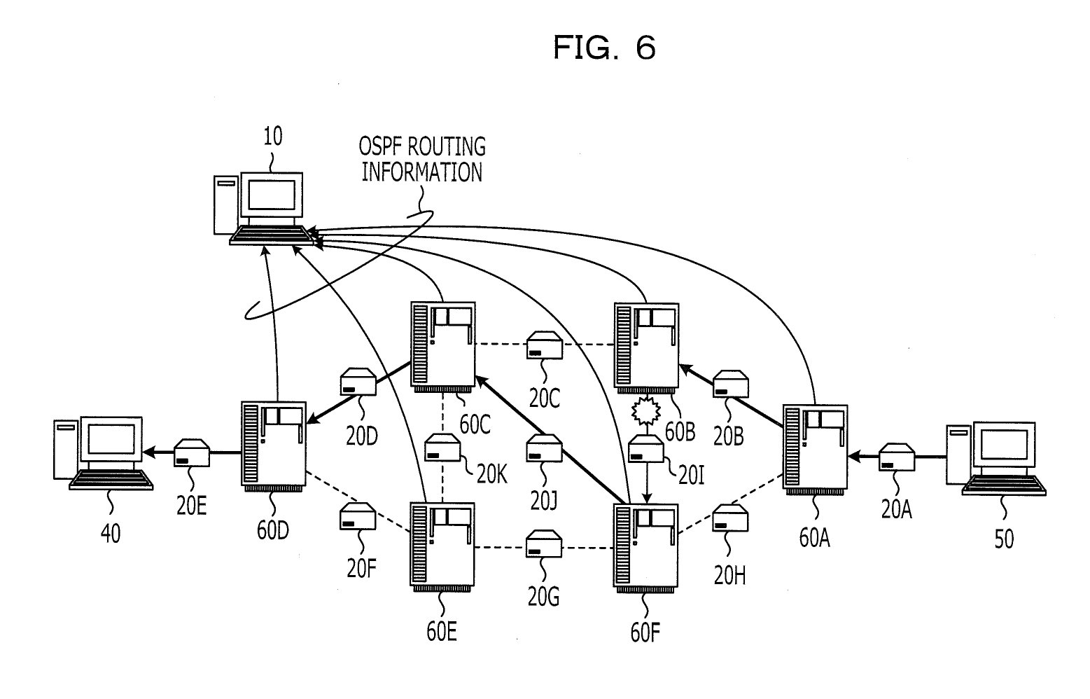

Management of communication path by the management section 12a will be discussed with reference to FIG. 6. FIG. 6 is a diagram illustrating an example of a communication path between the source host 50 and the destination host 40. In FIG. 6, attention is focused on the routers 60 connecting the destination host 40 and the source host 50 and an optimum path between the destination host 40 and the source host 50 is indicated by thick lines. As illustrated in FIG. 6, the manager 10 receives OSPF routing information from the routers 60A to 60F and grasps the optimum path between the destination host 40 and the source host 50 on the basis of the received OSPF routing information. FIG. 6 illustrates that a transmission path established by the source host 50, the routers 60A, 60B, 60F, 60C, and 60D, and the destination host 40 connected in that order is the optimum path.

The management section 12a has accepted setting of the positions of the probes 20 on links from a network operator in advance and stored the setting as Hop information in the routing information storage section 13b. For example, as illustrated in FIG. 6, the probes 20A, 20B, 20I, 20J, 20D, and 20E are arranged in that order on the optimum path between the source host 50 and the destination host 40. In this case, the management section 12a stores Hop information indicative of arrangement of the probes 20A, 20B, 20I, 20J, 20D, and 20E on the optimum path between the source host 50 and the destination host 40 into the routing information storage section 13b. The management section 12a reads the host names and the port numbers contained in statistical information stored in the statistical information storage section 13a to set host information and port information in the connection management table.

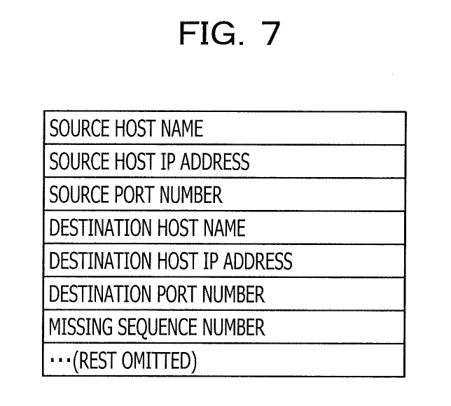

The reception section 12b receives failure information, serving as notice of the occurrence of packet loss, from any of the probes 20 through the maintenance link 70. For example, the reception section 12b receives failure information that contains information identifying a TCP connection and the sequence number of a lost packet. An example of the failure information will be discussed with reference to FIG. 7. FIG. 7 is a diagram illustrating an example of the failure information in the event of packet loss. As illustrated in FIG. 7, the reception section 12b receives, for example, a source host name, a source host IP address, a source port number, a destination host name, a destination host IP address, a destination port number, a missing sequence number and the like, as the failure information.

Upon receiving notice of packet loss from one probe (hereinafter, referred to as a “detector probe”) 20, the acquisition section 12c acquires a packet related to the loss from another probe 20 positioned closer to the source host 50 than the detector probe 20 on a packet communication path. For example, in the case where the reception section 12b receives failure information, the acquisition section 12c searches the connection management table stored in the routing information storage section 13b and determines a TCP connection related to the lost packet.

The acquisition section 12c determines a group of probes 20 on the path of the determined TCP connection on the basis of Hop information included in the connection management table. The acquisition section 12c then divides the group of probes 20 on the path into a group of preceding probes 20 (positioned closer to the source host than the detector probe 20 which has detected the packet loss) and a group of succeeding probes 20 (positioned closer to the destination host than the detector probe 20). For example, assuming that the probe D on the path detects loss and notifies the manager 10 of the loss in the case illustrated in FIG. 5, the preceding probe group corresponds to “A-C” and the succeeding probe group corresponds to “E-G-H”. For grouping into the preceding and succeeding probe groups, methods other than the above-discussed method of determining the grouping on the basis of OSPF routing information may be used. For example, the positional relationship between probes may be determined by comparison between transistor-transistor logic (TTL) information items included in IP headers of packets.

After that, the acquisition section 12c notices one probe (hereinafter, referred to as a “predecessor probe”) 20 among the preceding probes 20 of information concerning the lost packet to request to retrieve the lost packet. The acquisition section 12c may transmit the information to the predecessor probe 20 positioned closest to the source host 50 or the predecessor probe 20 positioned closest to the detector probe 20 which has notified of the packet loss. In the case where the acquisition section 12c fails to retrieve the lost packet, the acquisition section 12c requests a next option of the predecessor probe 20 to retrieve the lost packet. The acquisition section 12c may transfer the above-discussed failure information (refer to FIG. 7) to the predecessor probe 20 as the notice of the request to retrieve the lost packet.

The transmission section 12d transmits the packet acquired by the acquisition section 12c to another probe (hereinafter, referred to as a “successor probe”) 20 among the succeeding probes 20. For example, the transmission section 12d transmits, to a successor probe 20 positioned closest to the destination host 40 through the maintenance link 70, the packet acquired by the acquisition section 12c and a request to retransmit the packet to the destination host 40. As discussed above, since the manager 10 transmits the lost packet to the destination host 40 through the maintenance link 70, the manager 10 may bypass the data link 80 in which packet loss has occurred to retransmit the lost packet immediately and reliably.

Functional Configuration of Probe

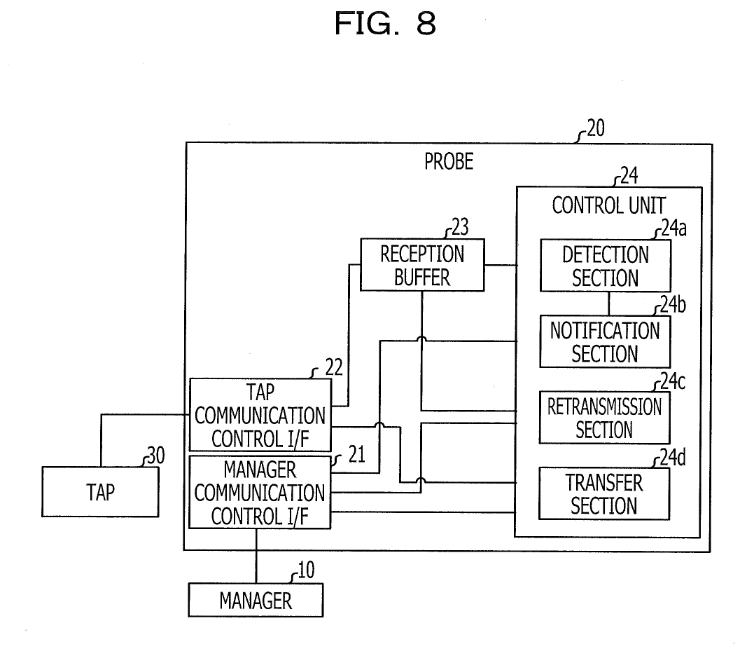

The functional configuration of each probe 20 illustrated in FIG. 1 will be discussed with reference to FIG. 8. FIG. 8 is a block diagram illustrating the functional configuration of the probe 20 in the first embodiment. As illustrated in FIG. 8, the probe 20 includes a manager communication control I/F 21, a TAP communication control I/F 22, a reception buffer 23, and a control unit 24, and is connected to the manager 10 and the corresponding TAP 30. Processes of these components will be discussed below.

The manager communication control I/F 21 controls communication related to various information items transmitted between the probe 20 and the manager 10. For example, the manager communication control I/F 21 periodically transmits statistical information of packets in a TCP connection to the manager 10. In the event of packet loss, the manager communication control I/F 21 transmits notice of the packet loss to the manager 10. In addition, the manager communication control I/F 21 receives a request to retrieve a lost packet from the manager 10.

The TAP communication control I/F 22 controls communication related to various information items transmitted between the probe 20 and the connected TAP 30. For example, the TAP communication control I/F 22 receives packets streaming on the data link 80 from the connected TAP 30.

The reception buffer 23 stores captured packets. The packets stored in the reception buffer 23 are read and analyzed by a detection section 24a, which will be discussed later. In addition, the reception buffer 23 is searched for the lost packet by a retransmission section 24c, which will be discussed later.

The control unit 24 includes an internal memory for storing programs defining various procedures and data and performs various processes on the basis of the programs and data. The control unit 24 further includes the detection section 24a, a notification section 24b, the retransmission section 24c, and a transfer section 24d.

The detection section 24a captures packets from the data link 80 and detects packet loss. For example, the detection section 24a checks the consistency of sequence numbers in TCP headers to determine whether any of the sequence numbers is missing. When determined the presence of a missing sequence number, the detection section 24a determines that the detection section 24a has detected the occurrence of packet loss.

In the case where the detection section 24a detects the packet loss, the notification section 24b notifies the manager 10 of the packet loss through the maintenance link 70. For example, in the case where the detection section 24a determines the presence of a missing packet sequence number, the notification section 24b transmits failure information (refer to FIG. 7) containing the sequence number of the lost packet to the manager 10.

The retransmission section 24c receives from the manager 10 information concerning the lost packet together with a request to retrieve the lost packet. The retransmission section 24c then tries to retrieve, from the reception buffer 23, a packet with a sequence number that matches the sequence number contained in the information concerning the lost packet. In the case where the packet with the sequence number that matches the sequence number contained in the information concerning the lost packet is stored in the reception buffer 23, the retransmission section 24c transmits the whole of packet data of the packet to the manager 10.

Upon receiving a packet retransmission request from the manager 10, the transfer section 24d transfers a packet to the destination host 40 through the data link 80. For example, when receiving the lost packet and the packet retransmission request from the manager 10, the transfer section 24d transfers the lost packet to the destination host 40 through the data link 80. Consequently, the lost packet reaches the destination host 40, so that the packet loss may be recovered. A range of packet retransmission is limited to an interval between the destination host 40 and the successor probe 20. Accordingly, the influence of a retransmission request on a network band may be suppressed.

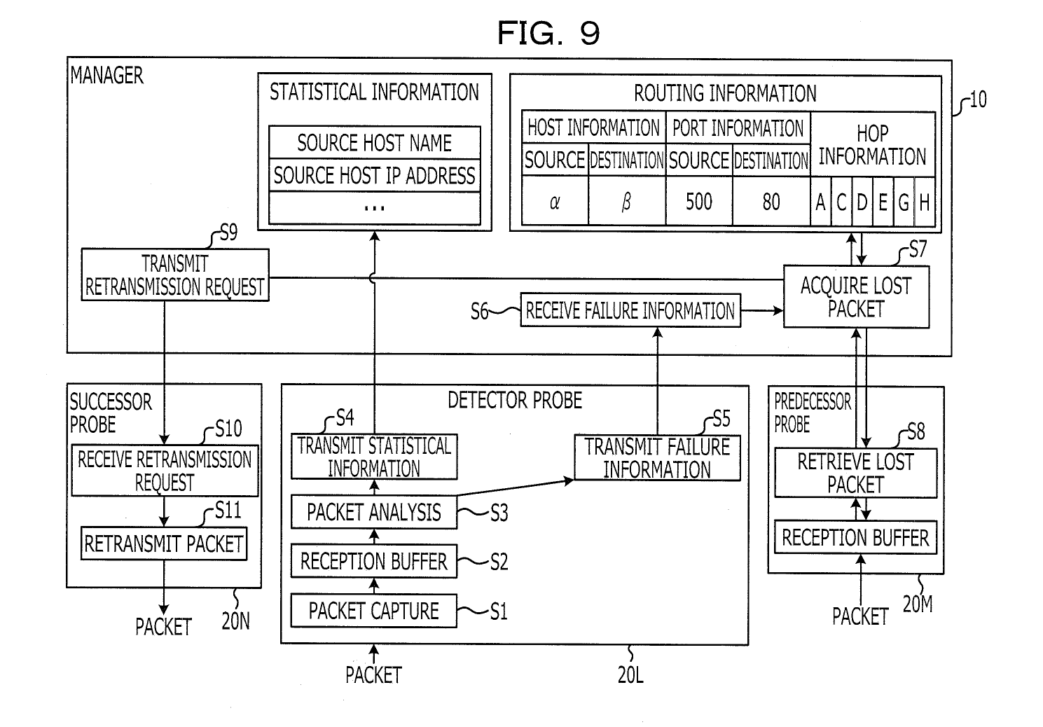

A packet loss recovery process performed by the manager 10 and the probes 20 will be discussed with reference to FIG. 9. FIG. 9 is a diagram for explaining the packet loss recovery process performed by the manager 10 and the probes 20. In FIG. 9, it is assumed that a detector probe 20L detects packet loss, that a predecessor probe 20M retrieves a lost packet, and that a successor probe 20N retransmits the lost packet.

In S1, the detector probe 20L captures packets streaming on the data link 80.

In S2, the detector probe 20L stores the packets into the reception buffer 23.

In S3, the detector probe 20L analyzes the packets stored in the reception buffer 23.

In S4, the detector probe 20L periodically transmits the result of analysis as statistical information about packets to the manager 10 through the maintenance link 70.

In S5, when determining the presence of a missing sequence number as a result of analysis, the detector probe 20L transmits failure information, serving as notice of the occurrence of packet loss, to the manager 10 through the maintenance link 70.

In S6, the manager 10 receives the failure information from the detector probe 20L through the maintenance link 70.

In S7, the manager 10 notifies the predecessor probe 20M of information concerning a lost packet, and requests the predecessor probe 20M to retrieve the lost packet in order to acquire the lost packet.

In S8, the predecessor probe 20M, upon receiving the retrieval request, retrieves the lost packet from the reception buffer 23 and transmits the lost packet to the manager 10 through the maintenance link 70.

In S9, the manager 10 transmits the acquired packet together with a packet retransmission request to retransmit the packet to the destination host 40 to the successor probe 20N through the maintenance link 70.

In S10, the successor probe 20N receives the packet retransmission request.

In S11, the successor probe 20N retransmits the packet to the destination host 40.

Process of Manager

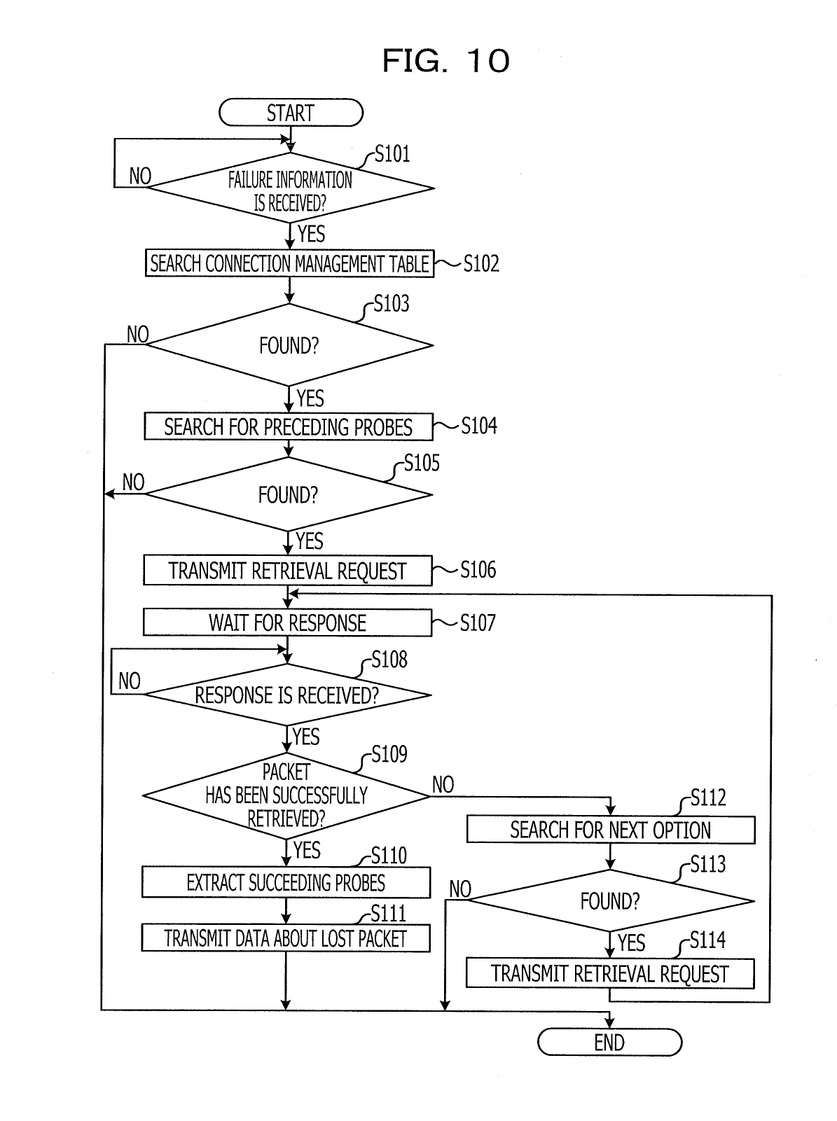

A process performed by the manager 10 according to the first embodiment will be discussed with reference to FIG. 10. FIG. 10 is a flowchart illustrating a procedure of the manager 10 according to the first embodiment.

In S101, the manager 10 waits for failure information indicative of packet loss.

In S102, when receiving failure information from any probe 20 (YES in S101), the manager 10 searches the connection management table in the routing information storage section 13b for a TCP connection related to a lost packet.

In S103, the manager 10 determines whether the connection management table contains a TCP connection related to the lost packet. If determining that the connection management table does not contain the TCP connection related to the lost packet (NO in S103), the manager 10 terminates the process.

In S104, if determining that the connection management table contains the TCP connection related to the lost packet (YES in S103), the manager 10 searches the Hop information for preceding probes 20.

In S105, the manager 10 determines whether the Hop information contains any preceding probes 20. If the Hop information contains no preceding probe 20 (NO in S105), the manager 10 terminates the process.

In S106, if the Hop information contains any preceding probes 20 (YES in S105), the manager 10 transmits a packet retrieval request to one (a predecessor probe) of the preceding probes 20.

In S107, the manager 10 waits for a packet retrieval response from the predecessor probe 20.

In S108, the manager 10 determines whether the packet retrieval response from the predecessor probe 20 is received. If the packet retrieval response from the predecessor probe 20 is not received (NO in S108), the manager 10 waits for the packet retrieval response.

In S109, if determining that the packet retrieval response from the predecessor probe 20 is received (YES in S108), the manager 10 determines whether the packet retrieval response indicates that the packet has been successfully retrieved.

In S110, if determining that the packet retrieval response indicates that the packet has been successfully retrieved (YES in S109), the manager 10 extracts succeeding probes 20 from the Hop information.

In S111, the manager 10 transmits data about the lost packet to one (a successor probe) of the succeeding probes 20. Thereafter, the manager 10 terminates the process.

In S112, if the packet retrieval response indicates that the packet has not been successfully retrieved (NO in S109), the manager 10 searches the Hop information for a next option of the predecessor probe 20. For example, the manager 10 selects a preceding probe 20 positioned closer to the source host 50.

In S113, the manager 10 determines whether the next option of the predecessor probe 20 is contained in the Hop information.

In S114, if the next option of the predecessor probe 20 is contained in the Hop information (YES in S113), the manager 10 transmits a request to retrieve the lost packet to the next option of the predecessor probe 20. Thereafter, the manager 10 returns the process to S107. If the next option of the predecessor probe 20 is not contained (NO in S113), the manager 10 terminates the process.

Process of Probe

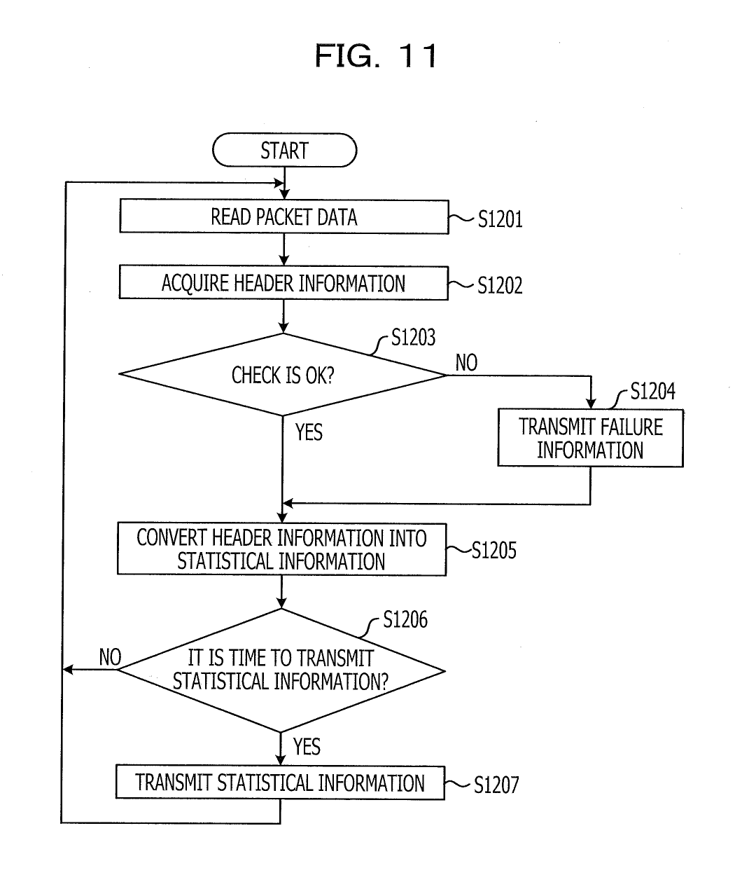

A process performed by the probe 20 according to the first embodiment will be discussed with reference to FIG. 11. FIG. 11 is a flowchart illustrating a procedure of the probe 20 according to the first embodiment.

In S1201, the probe 20 reads packet data from the reception buffer 23.

In S1202, the probe 20 acquires header information of the read packets. The probe 20 acquires, for example, IP addresses, port numbers, and sequence numbers of the packets from the header information.

In S1203, the probe 20 checks the consistency of the sequence numbers of the packets to determine whether the consistency check is OK. For example, the probe 20 determines whether any of the sequence numbers of the packets is missing.

In S1204, if determining that the consistency check is not OK (NO in S1203), the probe 20 transmits failure information about the packet determined as being lost to the manager 10. Whereas, if determining that the consistency check is OK (YES in S1203), the probe 20 advances the process to S1205.

In S1205, the probe 20 analyzes the header information and converts the header information into statistical information.

In S1206, the probe 20 determines whether it is time to transmit the statistical information.

In S1207, if it is time to transmit the statistical information (YES in S1206), the probe 20 transmits the statistical information accumulated for a given period of time to the manager 10. Thereafter, the probe 20 returns the process to S1201. If it is not time to transmit the statistical information (NO in S1206), the probe 20 returns the process to S1201.

### Advantages of First Embodiment

As discussed above, each probe 20 captures packets from the data link 80 to detect packet loss. When detecting packet loss, the probe (detector probe) 20 notifies the manager 10 of the packet loss through the maintenance link 70. When receiving notice of the packet loss from the probe 20 through the maintenance link 70, the manager 10 acquires a packet related to the loss through the maintenance link 70 from another probe (predecessor probe) 20 positioned closer to the source host 50 than the detector probe 20. The manager 10 then transmits the acquired packet to another probe (successor probe) 20 positioned closer to the destination host 40 than the detector probe 20 so that the packet is transferred to the destination host 40 through the data link 80. Upon receiving the packet from the manager 10, the successor probe 20 transfers the packet to the destination host 40 through the data link 80. Advantageously, the lost packet is retrieved from a highly reliable preceding probe, so that the lost packet may be transmitted to the destination host 40 through the maintenance link 70. Consequently, the lost packet may be transmitted while bypassing a data link 80 where the packet has been lost. The lost packet may be immediately and reliably retransmitted.

### Second Embodiment

The first embodiment has been discussed with respect to the case where the manager 10 receives notice of the occurrence of packet loss from any one of the probes 20. The embodiment is not limited to this case. For example, the manager 10 may receive notices of loss of the same packet from a plurality of detection apparatuses (probes 20) arranged on the same connection path. In such a case, the manager 10 may acquire the packet related to the loss in accordance with the first received notice.

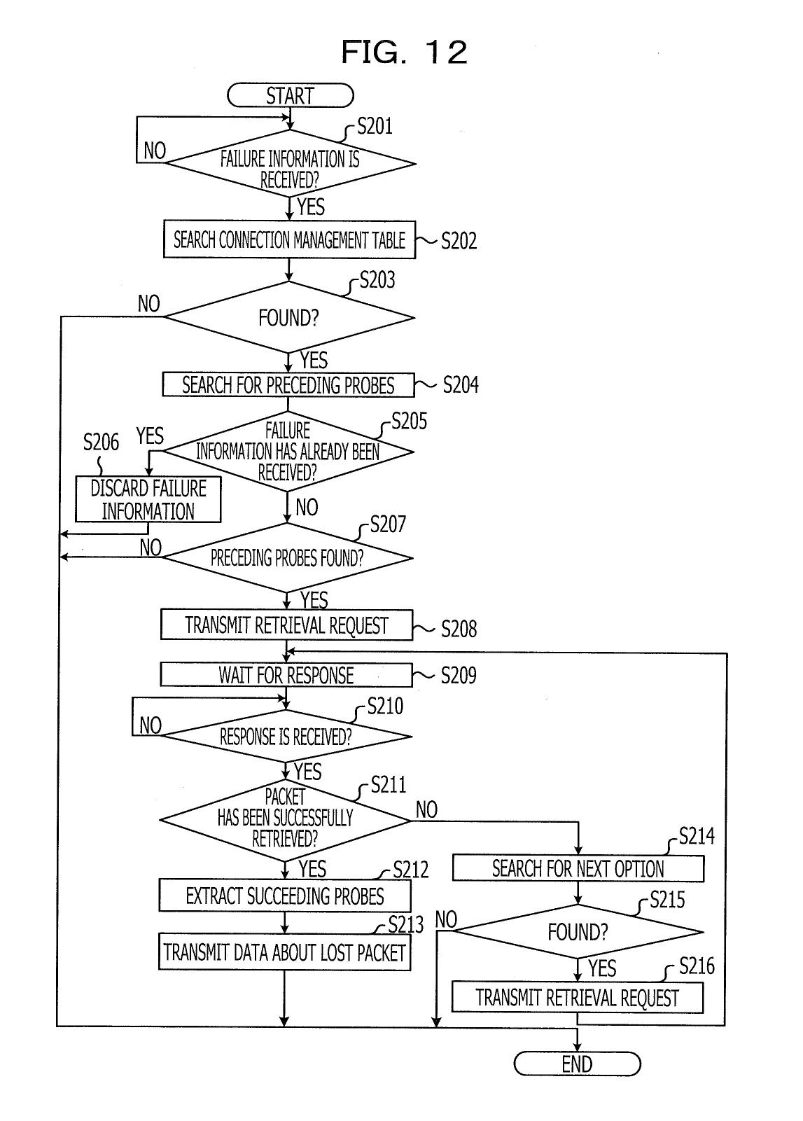

A second embodiment relates to a case where the manager 10 receives notice of loss of the same packet from each of detection apparatuses arranged on the same connection path and acquires the packet related to the loss in accordance with the first received notice. The second embodiment will be discussed below with reference to FIG. 12. FIG. 12 is a flowchart illustrating a procedure of the manager 10 in the second embodiment. Since a functional configuration of the manager in the second embodiment is the same as the functional configuration of the manager in the first embodiment discussed with reference to FIG. 3, a figure of the functional configuration will be omitted.

The procedure of the manager 10 in the second embodiment will be discussed with reference to FIG. 12.

In S201, the manager 10 waits for failure information indicative of packet loss.

In S202, when the manager 10 according to the second embodiment receives failure information from any one of the probes 20 (YES in S201), the manager 10 searches the connection management table in the routing information storage section 13b in a manner similar to the first embodiment.

In S203, the manager 10 determines whether the connection management table contains a TCP connection related to a lost packet.

In S204, if determining that the connection management table contains the TCP connection related to the lost packet (YES in S203), the manager 10 searches the Hop information for preceding probes 20.

In S205, the manager 10 according to the second embodiment determines whether the failure information has already been received from any of the preceding probes 20.

In S206, if determining that the failure information has already been received from any of the preceding probes 20 (YES in S205), the manager 10 discards the received failure information.

In S207, if determining that the failure information has not been received from any of the preceding probes 20 (NO in S205), the manager 10 determines whether the Hop information contains any preceding probes 20.

If the Hop information contains no preceding probe 20 (NO in S207), the manager 10 terminates the process.

In S208, if the Hop information contains any preceding probes 20 (YES in S207), the manager 10 transmits a packet retrieval request to one (a predecessor probe) of the preceding probes 20.

In S209, the manager 10 waits for a packet retrieval response from the predecessor probe 20.

In S210, the manager 10 determines whether the packet retrieval response is received from the predecessor probe 20. If the packet retrieval response is not received from the predecessor probe 20 (NO in S210), the manager 10 waits for the packet retrieval response.

In S211, if the packet retrieval response is received from the predecessor probe 20 (YES in S210), the manager 10 determines whether the packet retrieval response indicates that the packet has been successfully retrieved.

In S212, if the packet retrieval response indicates that the packet has been successfully retrieved (YES in S211), the manager 10 extracts succeeding probes 20 from the Hop information.

In S213, the manager 10 transmits data about the lost packet to one (a successor probe) of the succeeding probes 20.

In S214, if the packet retrieval response indicates that the packet has not been successfully retrieved (NO in S211), the manager 10 searches the Hop information for a next option of the predecessor probe 20.

In S215, the manager 10 determines whether the next option of the predecessor probe 20 is contained in the Hop information.

In S216, if the next option of the predecessor probe 20 is contained in the Hop information (YES in S215), the manager 10 transmits a request to retrieve the lost packet to the next option of the predecessor probe 20. Thereafter, the manager 10 returns the process to S209. If the next option of the predecessor probe 20 is not contained (NO in S215), the manager 10 terminates the process.

In the case where packet loss occurs at a single point on a TCP connection path, each of the probes 20 arranged downstream of the point may detect the packet loss and transmit failure information to the manager 10. In this case, the manager 10 recognizes the position of the probe 20 that has sent the failure information first among the probes 20 extracted from Hop information in the connection management table. After that, when receiving failure information from another probe 20, the manager 10 recognizes the position of the another probe 20. In the case where the another probe 20 succeeds to the probe 20 which has sent the failure information first, the manager 10 discards the failure information because the failure information items are overlapping.

In addition, in the case where the manager 10 receives failure information from a probe 20 preceding to the probe 20 which has sent the failure information first before receiving a response indicative of the result of retrieval, the manager 10 removes the preceding probe from target probes to which the manager 10 requests to retrieve a lost packet. Such a case will be discussed with reference to FIG. 5. Assuming that failure information transmitted from the probe 20D on the TCP connection path has reached the manager 10 first and a retrieval request has been transmitted to one of preceding probes 20. If the manager 10 subsequently receives failure information transmitted from the probe 20G or 20H, the manager 10 discards the received failure information and does not transmit a retrieval request to any preceding probe 20.

As discussed above, in the second embodiment, in the case where the manager 10 receives notices of loss of the same packet from the probes 20 arranged on the same connection path, the manager 10 acquires a packet related to the loss in accordance with the first received notice. Accordingly, the amount of information transmitted between the probes 20 and the manager 10 is reduced to a minimum amount. Thus, processing time for transmission and reception may be reduced and the amount of data streaming on the maintenance links 70 may be reduced.

### Third Embodiment

In the case where priorities are assigned to connection users, only a loss packet related to a connection for a user having a high priority contract may be acquired and transferred to a destination host.

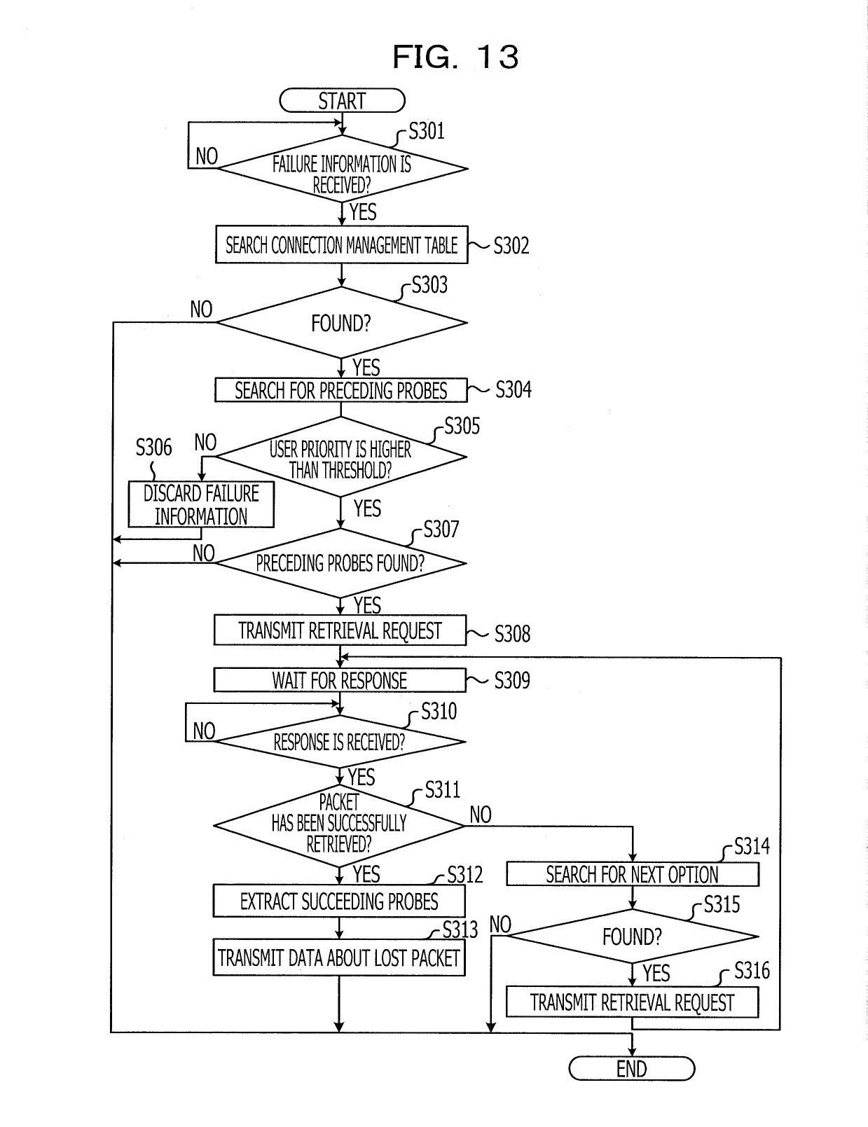

A third embodiment will be discussed with respect to a case where, when the manager 10 receives notice of the occurrence of packet loss, the manager 10 determines a priority assigned to a user of a connection related to a lost packet and acquires the lost packet so long as the priority is higher than a predetermined threshold. FIG. 13 is a flowchart illustrating a procedure of the manager 10 according to the third embodiment.

In S301, the manager 10 waits for failure information indicative of packet loss.

In S302, when receiving failure information from any one of the probe 20 (YES in S301), the manager 10 according to the third embodiment searches the connection management table in the routing information storage section 13b in a manner similar to the first embodiment.

In S303, the manager 10 determines whether the connection management table contains a TCP connection related to a lost packet.

In S304, if determining that the TCP connection is contained (YES in S303), the manager 10 searches the Hop information for preceding probes 20.

In S305, the manager 10 according to the third embodiment determines whether a priority assigned to a user of the connection is higher than the predetermined threshold.

In S306, if determining that the priority assigned to the user of the connection is not higher than the predetermined threshold (NO in S305), the manager 10 discards the received failure information.

In S307, if determining that the priority of the user of the connection is higher than the predetermined threshold (YES in S305), the manager 10 determines whether the Hop information contains any preceding probes 20.

If the Hop information contains no preceding probe 20 (NO in S307), the manager 10 terminates the process.

In S308, if the Hop information contains any preceding probes 20 (YES in S307), the manager 10 transmits a packet retrieval request to one (a predecessor probe) of the preceding probes 20.

In S309, the manager 10 waits for a packet retrieval response from the predecessor probe 20.

In S310, the manager 10 determines whether the packet retrieval response is received from the predecessor probe 20. If the packet retrieval response is not received from the predecessor probe 20 (NO in S310), the manager 10 waits for the packet retrieval response.

In S311, if the packet retrieval response is received from the preceding probe 20 (YES in S310), the manager 10 determines whether the packet retrieval response indicates that the packet has been successfully retrieved.

In S312, if the packet retrieval response indicates that the packet has been successfully retrieved (YES in S311), the manager 10 extracts succeeding probes 20 from the Hop information.

In S313, the manager 10 transmits data about the lost packet to one (a successor probe) of the succeeding probes 20.

In S314, if the packet retrieval response indicates that the packet has not been successfully retrieved (NO in S311), the manager 10 searches the Hop information for a next option the predecessor probe 20.

In S315, the manager 10 determines whether the next option of the predecessor probe 20 is contained in the Hop information.

In S316, if the next option of the predecessor probe 20 is contained in the Hop information (YES in S315), the manager 10 transmits a request to retrieve the lost packet to the next option of the predecessor probe 20. Thereafter, the manager 10 returns the process to S309. If the next option of the predecessor probe 20 is not contained (NO in S315), the manager 10 terminates the process.

Thus, so long as some of hosts on the network have a high-priority contract with a network provider, the manager 10 requests a preceding probe 20 to retrieve a lost packet. In the case where a user has a low priority, the manager 10 does not request a preceding probe 20 to retrieve the lost packet but notifies the user of the occurrence of packet loss.

As discussed above, in the third embodiment, when receiving notice of the occurrence of packet loss, the manager 10 determines a priority assigned to a user of a connection related to a lost packet. So long as the priority is higher than the predetermined threshold, the manager 10 acquires the lost packet. Accordingly, service may be differentiated for network users.

### Other Embodiments

While several embodiments have been discussed above, various modifications of the embodiments may be made in addition to the above-discussed embodiments. The modifications will be discussed below as other embodiments.

(1) Configuration of System

The components illustrated in the functional configuration of each apparatus represent functional concepts only and are not necessarily physically constructed as illustrated. In other words, specific distribution or integration of the components of each apparatuses is not limited to the illustrated one. A part or the whole of the components of each apparatuses may be functionally or physically distributed or integrated in any unit depending on various loads or usage of the apparatuses. For example, the management section 12a may be integrated with the reception section 12b. All or any part of processing functions performed in each apparatus may be implemented by a CPU and programs interpreted and executed by the CPU, or may be implemented as wired logic based hardware.

(2) Programs

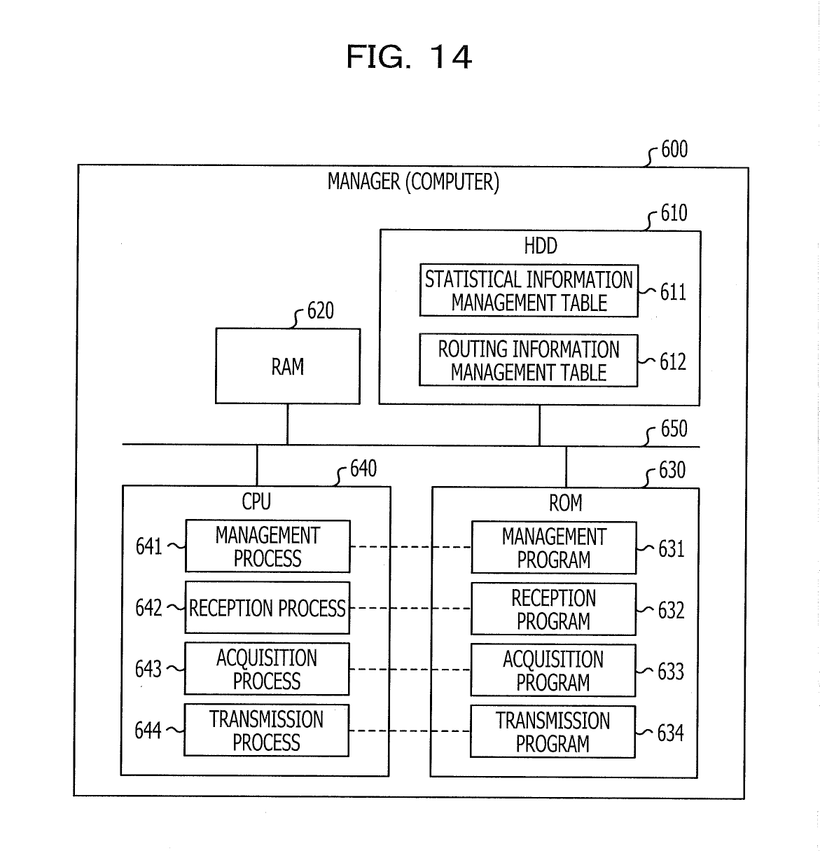

The various processes discussed in the foregoing embodiments may be achieved by implementation of prepared programs through a computer. An example of the computer that implements programs having functions similar to those discussed in the foregoing embodiments will be discussed with reference to FIG. 14. FIG. 14 is a diagram illustrating the computer that implements a packet loss recovery process.

As illustrated in FIG. 14, the computer 600, serving as a manager, includes a hard disk drive (HDD) 610, an RAM 620, an ROM 630, and a CPU 640 which are connected through a bus 650.

The ROM 630 has previously stored packet communication programs which provide functions similar to the foregoing embodiments, namely, a management program 631, a reception program 632, an acquisition program 633, and a transmission program 634 as illustrated in FIG. 14. The programs 631 to 634 may be properly integrated or distributed like the components of the manager 10 illustrated in FIG. 3.

The CPU 640 reads the programs 631 to 634 from the ROM 630 and implements the programs, so that the programs 631 to 634 function as a management process 641, a reception process 642, an acquisition process 643, and a transmission process 644 as illustrated in FIG. 14.

The HDD 610 contains a statistical information management table 611 and a routing information management table 612 as illustrated in FIG. 14. The CPU 640 stores data into the statistical information management table 611 and the routing information management table 612, reads data from the statistical information management table 611 and the routing information management table 612, stores the read data into the RAM 620, and performs a process on the basis of the data stored in the RAM 620.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A management apparatus communicable with a plurality of detection apparatuses for detecting a loss of a packet transmitted from a source apparatus to a destination apparatus, the plurality of detection apparatuses being disposed on a communication path of a connection between the source apparatus and the destination apparatus, the management apparatus comprising:
a processor to
acquire, upon receiving a notice of the loss of a packet from a first detection apparatus, the lost packet from a second detection apparatus disposed on a communication path between the source apparatus and the first detection apparatus, and
transmit the lost packet to a third detection apparatus disposed on a communication path between the first detection apparatus and the destination apparatus.

2. The management apparatus according to claim 1, wherein
the processor acquires the lost packet in response to an earliest notice among a plurality of notices and does not acquire the lost packet in response to other notices among the plurality of notices when the plurality of notices notify of the loss of the lost packet and have been received from any of the plurality of detection apparatuses.

3. The management apparatus according to claim 1, wherein
the processor further determines, upon receiving the notice, a priority level of a user of the connection, and
the processor acquires the lost packet when the determined priority level is higher than a predetermined value and does not acquire the lost packet when the determined priority level is lower than the predetermined value.

4. The management apparatus according to claim 1, wherein
the plurality of detection apparatuses are disposed on a first network connected to the source apparatus and the destination apparatus, and
the management apparatus is connected to the plurality of detection apparatuses through a second network.

5. A communication system for transferring a packet from a source apparatus to a destination apparatus, the communication system comprising:
a plurality of detection apparatuses disposed on a communication path of a connection between the source apparatus and the destination apparatus, each of the plurality of detection apparatuses including a first processor to
detect a loss of the packet,
transmit a notice of the loss of the packet upon detecting the loss of the packet, and
transfer the lost packet to the destination apparatus upon receiving the lost packet; and
a management apparatus including a second processor to
acquire, upon receiving the notice from a first detection apparatus, the lost packet from a second detection apparatus disposed on a communication path between the source apparatus and the first detection apparatus, and
transmit the lost packet to a third detection apparatus disposed on a communication path between the first detection apparatus and the destination apparatus.

6. A communication method for transferring a packet from a source apparatus to a destination apparatus, the communication method comprising:
detecting, by a first detection apparatus, a loss of the packet;
transmitting, by the first detection apparatus, a notice of the loss of the packet to a management apparatus upon detecting the loss of the packet;
acquiring, by the management apparatus, the lost packet from a second detection apparatus disposed on a communication path between the source apparatus and the first detection apparatus upon receiving the notice;
transmitting, by the management apparatus, the lost packet to a third detection apparatus disposed on a communication path between the first detection apparatus and the destination apparatus; and
transferring, by the third detection apparatus, the lost packet to the destination apparatus upon receiving the lost packet.
